(19) United States
(12) Patent Application Publication
(10) Pub. No.: US 2006/0224700 A1
(43) Pub. Date: Oct. 5, 2006

(54) Multipart response generation

(75) Inventors: Susan Chory, Seattle, WA (US); Andrew Cheng-min Lin, Seattle, WA (US); Nikhil Kothari, Sammamish, WA (US); Shanku Shivabrata Niyogi, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/081,126

(22) Filed: Mar. 15, 2005

(51) Int. Cl. G06F 15/16

(52) U.S. Cl. 709/219

(57) ABSTRACT

A multipart response generation system generates content (such as pages) that may contain mixed linked content that is referenced by a separate locator. When a page is requested (during a “primary request”), the image and PDF file, for example, based on specific input from the user are generated and each piece of the generated content with a specific locator is associated therewith. The generated content may be stored in a cache with a specific expiration time. The page rendered to the client contains the associated locators as well as any static content such that the client automatically fetches (as secondary requests) the content in accordance with the associated locators. The secondary requests are retrieved, the generated content from the cache are retrieved, the correct content-type in the response are specified and then returned to the client, which displays the returned mixed content within the page.

### BACKGROUND

Complex web applications often need to respond to user input requests (or other pertinent data such as date, time, and the like) and generate content tailored to each specific request. This task usually can be accomplished in conventional systems when the information that is generated can be displayed in an HTML or web page: the page that is requested retrieves the data and formats it for display as HTML in the returned page.

The complexity of this task is greatly increased if the information that is created for the end user is, for example, an image (e.g., a sales chart) or a PDF file or Excel file that contains the information (in the context of an overall presentation such as an HTML page or other document). The stateless web farm environment of the web and the increased use of media that cannot be presented in HTML (such as any streaming file format) are problems that effect an increasing number of web applications.

### SUMMARY

The present disclosure is directed to multipart response generation for application programs (including web page applications) that may contain mixed linked content that is referenced by a separate locator such as a dynamic image, and a dynamic PDF file. When a page is requested (during a “primary request”), the image and PDF file, for example, based on specific input from the user (e.g. stock ticker symbol) are generated and each piece of the generated content with a specific locator is associated therewith. The generated content may be stored in a cache with a specific expiration time. The page rendered to the client contains the associated locators as well as any static content such that the client automatically fetches (as secondary requests) the content in accordance with the associated locators. The secondary requests are retrieved, the generated content from the cache are retrieved, the correct content-type in the response are specified and then returned to the client, which displays the returned mixed content within the page. Accordingly, a framework is implemented for allowing the content to be generated (or fetched) and a facility is provided for caching the data used to create (or pass) the data back and forth in accordance with an associated locator.

In accordance with one aspect of the invention, a computer-implemented method is disclosed for retrieving media content, comprising: receiving a primary request for requested content from a client; sending a primary response to the client, wherein the primary response comprises at least one locator for the requested content; receiving a secondary request from the client, wherein the secondary request comprises one of the locators for the requested content; and sending a secondary response to the client, wherein the secondary response is associated with the one of the locators that is comprised by the secondary request for the requested content.

### BRIEF DESCRIPTION OF THE DRAWINGS

FIG. 1 illustrates a computing device that may be used according to an example embodiment of the present invention.

FIG. 2 illustrates a block diagram of a system for multipart response generation using delayed mechanisms in accordance with at least one aspect of the present invention.

FIG. 3 illustrates a block diagram of an alternative system for multipart response generation using synchronous mechanisms in accordance with aspects of the present invention.

### DETAILED DESCRIPTION OF THE PREFERRED EMBODIMENT

The present disclosure is directed to multipart response generation for client applications (including web page applications) that may contain mixed linked content that is referenced by a separate locator such as static text, a dynamic image, and a dynamic PDF file. When a page is requested (during a “primary request”), the image and PDF file, for example, based on specific input from the user (e.g. stock ticker symbol) are generated and each piece of the generated content with a specific locator is associated therewith. The generated content may be stored in a cache with a specific expiration time. The page rendered to the client contains the associated locators as well as any static content such that the client automatically fetches (as secondary requests) the content in accordance with the associated locators. The secondary requests are retrieved, the generated content from the cache are retrieved, the correct content-type in the response are specified and then returned to the client, which displays the returned mixed content within the page.

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

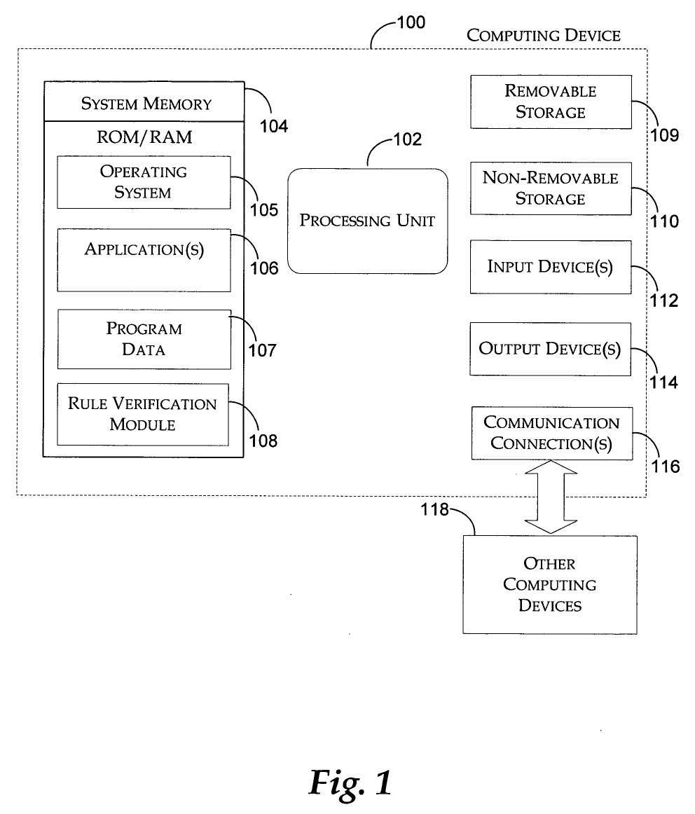

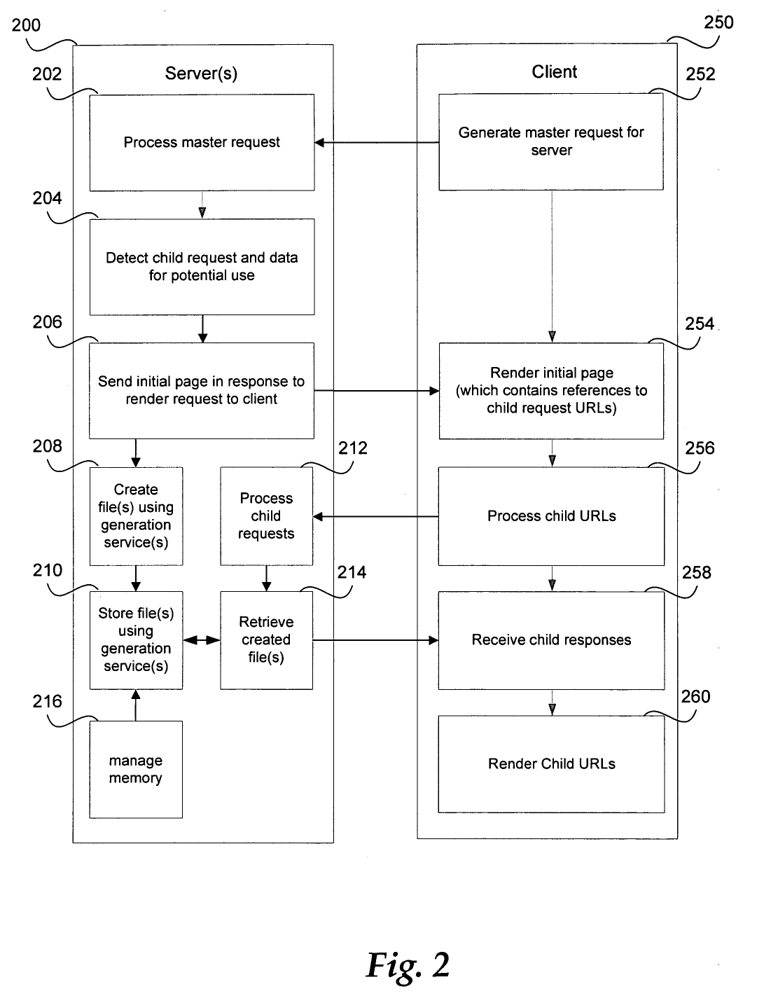

With reference to FIG. 1, one example system for implementing the invention includes a computing device, such as computing device 100. Computing device 100 may be configured as a client, a server, a mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. A rule verification module 108, which is described in detail below with reference to FIGS. 2-4, is implemented within system memory 104.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Multipart Response Generation

FIG. 2 illustrates a block diagram of a system for multipart response generation using delayed mechanisms in accordance with aspects of the present invention. A system in accordance with the invention is described with reference to content generation services that are provided by one or more servers, such as server 200. Server 200 is configured to, for example, dynamically create images from data and serve them to a browser, which could be hosted on client 250.

Although the system is generally describe as using web protocols, the system is not limited to the web space. The system can be implemented on any system that is used to request and display content. Furthermore, although the system is generally described with respect to dynamically created images, the system can be used to generate or serve any media content (such as Microsoft Corporation's Word-formatted documents). The system may also be integrated with any type of run time object such that images can be generated or fetched using secondary responses in accordance with a client request. The system can be used to implement a framework that enables interoperability by providing consistent ways for content generators (such as those provided by third parties) to “plug in” to the system.

Server 200 can dynamically generate content for a particular user in response to a user request. In an example scenario, the user would like to generate a chart of the user's stock portfolio. The user can enter a user name and password, and request the information to be displayed. Server 200 can provide an initial page to be rendered on a browser of client 250, while concurrently locating information and/or generating charts to be displayed on the browser. In this scenario, the information can be located (and/or charts generated) in response to a provide user's profile.

Server 200 typically generates one or more secondary processes for generating images or streaming any kind of content in response to a primary request from client 250. Additionally, custom report generators can be used to generate any kind of desired report, and any non-typical web displayed items that may require a special display can be used. Accordingly, content that is difficult or impossible to code using HTML (for example), can be presented in the context of a page.

One or more locators (such as web addresses or URIs) can be associated with the secondary processes. The locators are sent to the browser of client 250 in a primary response (such as a web page) while the resources been pointed to by locators are being generated and/or retrieved. Accordingly, the browser of client 250 can begin to render the primary response, while starting to send out request for the resources pointed to by the locators (secondary requests). The requests for the resources are accomplished transparently to the user of browser, so no intervention is required by the user, and typically the user is unaware of the secondary processes.

Additionally, server 200 can be implemented securely, in a cache environment, on web servers or web farms, with the secondary processes being distributed amongst many different servers. Server 200 typically logically associates the primary responses with the secondary responses and enforces the appropriate security and expiration. The system implemented with server 200 and client 250 is configured to provide web programmers and content providers a declarative way (e.g., a tag-based method) of coordinating the mechanisms of the system.

The system includes server 200 and client 250. Although server 200 and client 250 are shown in block form in the Figure, it is understood that the functionality described in relation to the blocks can be distributed among various systems. Generally, server 200 comprises the ability to manage and coordinate the generation of content from data, enforce storage policies for the generated content, and coordinate sending the generated content to client 250.

Server 200 can enable content to be generated via delayed mechanisms and/or synchronous mechanisms. The delayed mechanisms generate content in response to receiving the primary request from client 250. The synchronous mechanisms generate content in response to receiving secondary requests from client 250. Server 200 can also generate content using both synchronous mechanisms and delayed mechanisms, where (for example) the choice in the mechanism may depend upon the type of the content to be generated.

A web developer can thus create pages that contain dynamically created images. Such images may comprise time-sensitive information such as sales data, stock prices, and the like. Accordingly, the developer can direct the page to request that server 200 generate one or more images. In various embodiments, the system can use an image generation service, which can be provided by server 200 or “plug in” third party sources. The services may be predefined in the application, imported from a third party source (e.g., a vendor), generated from an existing component or created by the web developer.

In block 252, a browser (for example) on client 250 generates a primary request for a page. The request can be generated in response to a user requesting the page. The page may comprise static information as well complex information that is to be generated or fetched. Additionally, parameters related to the size and capabilities of the requesting device (e.g., cell phone) can be sent to the server 200. Based on this additional information, the generation service of server 200.

Furthermore, server 200 can adapt the generated information to meet the capabilities of the device. For example, when the request for the page comes from a desktop browser, server 200 might generate a relatively large image (and/or having a relatively large amount of text), whereas when the request comes from a mobile cell phone browser, it could provide a black-and-white only bitmap (BMP) image.

In block 202, server 200 receives the primary request and processes the request. Secondary requests and data that might potentially be used are detected in block 204. The secondary requests are typically used to request dynamically generated images (or other content). Data retrieved for rendering (in a table, for example) as part of the primary request can also be passed on to the content generation service for use in handling the secondary request. Thus the data would be fetched once, as compared to twice (e.g., once for the primary request handling, and once again for the secondary request handling).

In block 206, an initial page is created in response to the detected primary requests and potentially useable data. Locators (URLs or any other suitable identifier) can be used by components of server 200 to route requests. The components typically route requests in response to a predetermined file extension (which is usually contained in the request) by mapping the request to a content generation service (rather than by mapping the request to a file location). The initial page is sent to client 250, with the initial page containing references to the secondary request locators. Additionally, an instruction to create (or locate, for example) one or more files (or streaming content, for example) is generated.

In block 208, the potential data are stored for the generation services. The data are typically stored in a cache such that they can be retrieved by association with the secondary request locators. The contents of the cache can be encrypted in memory or on disk to increase performance and security. Additionally, the data (if small enough) could be stored and/or transmitted using base-64 encoding (as part of the URI information, for example, which saves space that otherwise would be required on server 200).

In block 210, generation services are used to dynamically create content. The content can be created from time-sensitive data, as described above. In the case where multiple files are to be generated, the files may be generated serially and/or parallel-wise such that performance and/or cost can be optimized. If the requested files for the content already exist, the files do not need to be generated, and the expiration time for the files in the cache can be adjusted accordingly.

Block 216 provides memory and/or storage management services. Such services may include allocating memory, verifying files for expiration, deleting expired files, coordination of expiration times, and the like.

In block 254, the initial page is received and correlated with the request that was generated in block 252. The initial page is rendered (or cached locally, for example). Rendering may include formatting the page and displaying at least a part of the formatted content.

In block 256, the secondary locators of the initial page are processed. The addresses of the secondary request locators are used to send to client 200 at least one request for the data.

In block 212, the request for the dynamically generated content is processed and the files for the dynamically created images are identified. The files are located, and retrieved for sending to client 250.

In block 258, client 250 receives the dynamically generated content. The images can be correlated with the secondary locators by which the images were requested. If one (or more) of the spawned requests fails to execute accordingly, error information for the failed spawned request can be retrieved. The files are rendered in block 260 for display. The files may be rendered in context of the initial page that was rendered in block 254.

As mentioned above, server 200 and client 250 can be adapted to handle streaming content. The content can be specified in the secondary requests, located and retrieved from various databases, and streamed to client 250 similarly to the process described above.

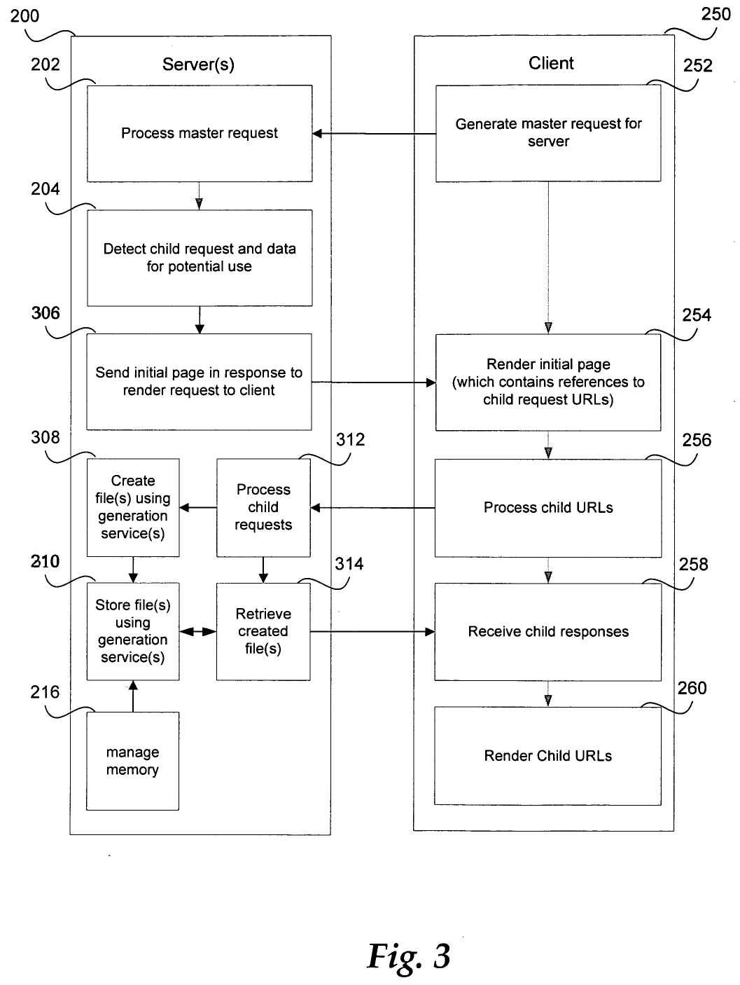

FIG. 3 illustrates a block diagram of an alternative system for multipart response generation using synchronous mechanisms in accordance with aspects of the present invention. The system operates similarly to the system described with respect to FIG. 2, but optionally create files in response to secondary requests received from client 250.

In block 306, an initial page is created in response to the detected secondary requests and potentially useable data. Locators are used in the initial page to indicate where to request dynamically created images. The initial page is sent to client 250, with the initial page containing references to the secondary request locators.

In block 312, the request for the dynamically created images is processed. The store data services in block 308 are instructed to locate and store data in response to the secondary request locators.

In block 308, generation services are used to dynamically create the files that have been identified by the secondary request locators. The stored data are used to generate content in block 310 and retrieved in block 312 for sending to client 250 when the files are ready to be sent.

The specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for retrieving content, comprising:
receiving a primary request for requested content from a client;
sending a primary response to the client, wherein the primary response comprises at least one locator for the requested content;
receiving a secondary request from the client, wherein the secondary request comprises one of the locators for the requested content; and
sending a secondary response to the client, wherein the secondary response is associated with the one of the locators that is comprised by the secondary request for the requested content.

2. The computer-implemented method of claim 1, wherein the secondary response comprises content that is generated before the secondary request is received from the client.

3. The computer-implemented method of claim 1, wherein the secondary response comprises content that is generated after the secondary request is received from the client.

4. The computer-implemented method of claim 1, wherein the secondary response comprises content that is generated in response to the primary request from the client.

5. The computer-implemented method of claim 1, wherein the primary response comprises a markup language file that comprises the at least one locator for the requested content.

6. The computer-implemented method of claim 1, wherein the primary response comprises a markup language file that comprises static data.

7. The computer-implemented method of claim 1, wherein the primary request comprises information about device characteristics of the client.

8. The computer-implemented method of claim 7, wherein the secondary response comprises content that is generated in response to the information about device characteristics of the client.

9. The computer-implemented method of claim 1, wherein the locators are in accordance with the http protocol.

10. The computer-implemented method of claim 1, further comprising treating data that is associated with the primary and secondary responses as a single logical entity, whereby substantially similar actions are performed on the primary and secondary responses that are associated with the single logical entity.

11. The computer-implemented method of claim 10, wherein the treating data comprises caching data that is associated with the primary and secondary responses in accordance with security policies that are associated with the single logical entity.

12. A computer-readable medium, comprising instructions for:
receiving a primary request for requested content from a client;
sending a primary response to the client, wherein the primary response comprises at least one locator for the requested content;
receiving a secondary request from the client, wherein the secondary request comprises one of the locators for the requested content; and
sending a secondary response to the client, wherein the secondary response is associated with the one of the locators that is comprised by the secondary request for the requested content.

13. The computer-readable medium of claim 12, wherein the instructions for sending the secondary response comprise instructions for generating content generated before the secondary request is received from the client.

14. The computer-readable medium of claim 12, wherein the instructions for sending the secondary response comprise instructions for generating content generated after the secondary request is received from the client.

15. The computer-readable medium of claim 12, wherein the instructions for sending the primary response comprise instructions for generating a markup language file that comprises the at least one locator for the requested content.

16. The computer-readable medium of claim 12, wherein the instructions for the receiving the primary response comprise instructions for determining device characteristics of the client.

17. A system for presenting content, comprising:
means for receiving a primary request for requested content from a client;
means for sending a primary response to the client, wherein the primary response comprises at least one locator means for the requested content;
means for receiving a secondary request from the client, wherein the secondary request comprises one of the locator means for the requested content; and
means for sending a secondary response to the client, wherein the secondary response is associated with the one of the locator means that is comprised by the secondary request for the requested content.

18. The system of claim 17, further comprising means for determining information about device characteristics of the client.

19. The system of claim 18, further comprising formatting means for formatting the primary response in response to the information determined about device characteristics of the client.

20. The system of claim 17, further comprising caching means for managing storage of generated content.
